(19) United States
(12) Patent Application Publication
(10) Pub. No.: US 2022/0198036 A1
(43) Pub. Date: Jun. 23, 2022

(54) SYSTEMS AND METHODS FOR FACILITATING PROTECTING RECIPIENT PRIVACY

(71) Applicant: SHOPIFY INC., Ottawa (CA)

(72) Inventor: Samaneh BAYAT, Kanata (CA)

(21) Appl. No.: 17/128,908

(22) Filed: Dec. 21, 2020

(51) Int. Cl. G06F 21/62; G06Q 10/08; G06Q 20/38; G06Q 30/06

(52) U.S. Cl. CPC G06F 21/6209; G06Q 30/0635; G06Q 20/383; G06Q 10/0833

(57) ABSTRACT

Disclosed are systems and methods for facilitating gift purchases by a buyer on an e-commerce platform when the buyer does not know a recipient's destination address without revealing the recipient's destination address to the buyer. A computer receives information for a recipient of an online order associated with a merchant for delivery to the recipient. The computer queries a database using the recipient information to obtain the recipient's destination address. The computer generates a token corresponding to the destination address, where the token includes an obfuscated representation of the destination address. The computer transmits the token to a client device for submission of the online order for delivery to the recipient, where the token is adapted to satisfy a requirement to provide the destination address for the online order. When the computer receives the token from a merchant device, the computer presents the destination address to the merchant device.

### TECHNICAL FIELD

This application relates generally to information privacy and, more particularly, to maintaining account privacy when conducting transactions requiring certain types of account information.

### BACKGROUND

When ordering gifts from an e-commerce merchant, a buyer needs to input a destination address for delivery to an intended recipient. However, the buyer often does not have the destination address for the recipient, making it difficult for the buyer to complete an online order. When a third party provides the destination address to the buyer, then the recipient is not protected from improper use by someone who does not know the recipient but uses or exploits the third party to obtain the recipient's personal information. The bad actor could also abuse the system to send the recipient unwanted items.

### BRIEF DESCRIPTION OF THE DRAWINGS

The accompanying drawings constitute a part of this specification and illustrate embodiments of the subject matter disclosed herein.

FIG. 1 illustrates an e-commerce platform, according to an embodiment.

FIG. 2 depicts an embodiment for a home page of an administrator, according to an embodiment.

FIG. 3 shows components of a system, according to an embodiment.

FIG. 4 shows steps of executing a method by an end-user client device, according to an embodiment.

FIG. 5 shows steps of executing a method by a server of an e-commerce platform, according to an embodiment.

FIG. 6 shows steps of executing a method by a merchant server, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

A merchant's online store is accessible to buyers such as, for example, through browser-based webpages or a native buyer application (“buyer app”) installed on the buyer's device. Whenever the buyer places an online order through the merchant's online store, the buyer must enter payment and shipping information into fields of a purchase order form. These fields typically include some combination of buyer information (e.g., buyer name, buyer's user identifier), billing information (e.g., credit/debit card number, billing address), recipient information (e.g., name, email address), and shipping information (e.g., destination address for recipient). The buyer inputs this information to the online store for the merchant to process the transaction and ship the product. When the online store is hosted by an e-commerce platform, the e-commerce platform processes, validates, and stores this information into a platform database of the e-commerce platform.

The buyer app enables efficient interactions with the merchant's online store and allows the buyer to track orders, shipments, payment preferences, and other types of order data. The buyer app allows the buyer to issue queries to other components of the buyer's device, such as a native contacts application (“contacts app”), for information about the intended recipient. When the buyer is submitting an online order, the buyer can indicate the online order is a gift. If the buyer app or e-commerce platform detects the gift indication, then the buyer app issues a seeded query (drawing upon the buyer's inputted recipient information and/or the results from querying the contacts app) to the platform database. The platform database then determines whether the recipient information (e.g., name, social media handle, unique identifier) received in the seeded query from the buyer device matches any stored information of known recipients (who have previously provided permission for the platform to use their information for receiving gifts).

When there is a match between the received recipient information and stored recipient information, and the recipient's stored information passes the validation requirements of the particular order form (e.g., physical address is included in full, phone number is included, etc.), the e-commerce platform then generates a token of an obfuscated version of certain portions of the recipient information in the database (e.g., destination address, account identifier). The e-commerce platform returns the token to the buyer device. The buyer device uses the token in the place of the recipient's destination address to complete and submit the online order to the merchant's shop, the e-commerce platform can get the clear version of the addressing information using the provided token. In an optional embodiment, the token includes various information about the transaction useful to the merchant, such as information for merchant to calculate tax, shipping costs, and/or recipient information. The merchant's server decodes the token to retrieve the information, though the recipient's personal information (e.g., address) remains inaccessible to the buyer. Prior to completing the transaction, the merchant server sends the additional cost information to the buyer device, which is presented to the buyer before finalizing payment.

The recipient information is obfuscated from the buyer and the buyer's device, such as by using encryption or hashing (e.g., using a hash function that is not easily inverted such as, for example, a cryptographic hash like SHA-256) to generate a new alphanumeric string, displaying a blurred or hidden version of the characters, presenting shapes or symbols in the place of characters, or other methods for hiding the recipient's information (e.g., displaying the received recipient information from the original query and an indication that an address match has been made). In some configurations, the token contains information about the recipient that the merchant uses to request the recipient address from the e-commerce platform. For example, the token might contain an account identifier for the recipient, which the merchant can issue as a query to the e-commerce platform database. The e-commerce platform can then return the recipient address to the merchant for processing the order without providing the address to the buyer.

Before or while running the seeded query, the e-commerce platform can validate the intended recipient information, confirm the intended recipient of the order, and/or verify whether the buyer should be able to send gifts to the intended recipient. The e-commerce platform can review the information received from the buyer to determine whether the seeded query can be completed based on the amount/quality of the information. The e-commerce platform could also compare the stored recipient information against the information received from the buyer device to validate that the received recipient information is accurate and/or complete and, if needed, request additional information from the buyer.

The e-commerce platform can request the buyer to confirm the identity of the intended recipient. For example, in some circumstances, the platform database may contain a plurality of candidate recipients whose information is similar to the recipient information received from the buyer device. In these circumstances, the e-commerce platform requests that the buyer indicate which of the candidate recipients is the buyer's intended recipient (i.e., to disambiguate between the candidate recipients). The confirmation prompt containing the set of candidates can present the buyer with the set of candidates without revealing any personal information about the candidate recipients that is not already known by the buyer. As such, the set of candidates can be limited according to the additional recipient information received from the buyer. For instance, where the e-commerce platform identifies several candidates, the e-commerce platform can request the buyer to input, e.g., the city where the intended recipient resides.

The e-commerce platform can also verify that the buyer is permitted to send gifts to the recipient using a request for additional recipient information from the buyer. The request for additional information would require the buyer to correctly answer a question related to the recipient or otherwise submit additional information about the recipient. The e-commerce platform could also verify that the buyer is permitted to send gifts to the recipient by, for example, querying the platform database for buyer/recipient information suggesting a prior relationship (e.g., prior purchases or transactions, user profiles/configurations) or receiving the indicator from the buyer device that the recipient information was found in the contacts app.

Optionally, the buyer app can validate the intended recipient information, confirm the intended recipient of the order, and/or verify whether the buyer should be able to send gifts to the intended recipient. The buyer app can use the recipient information to query to the contacts app of the buyer device. The buyer app may use information retrieved from the contact app to validate the accuracy and/or completeness of the recipient information initially entered by the buyer before sending the recipient information to the e-commerce platform.

The buyer app can also (additionally or alternatively) use information retrieved from the contacts app to confirm that the recipient suggested by the buyer's inputs is actually the buyer's intended recipient. This can be beneficial, for example, when the contacts app contains more than one candidate recipient with at least some information similar to the recipient information initially entered by the buyer. In these cases, the buyer app requests that the buyer indicate which of the candidate recipients is the buyer's intended recipient.

The buyer app can also verify that the buyer should be permitted to send gifts to the recipient using the recipient information retrieved from the contacts app. The buyer app may require that the contacts app contain a certain type or amount of recipient information before proceeding to submit the seeded query to the platform database. Alternatively, the buyer app can send an indicator to the e-commerce platform that some or all of the recipient information of the seeded query was appropriately found on the contacts app. The e-commerce platform would then consider this indicator as verification that some level of relationship exists.

When the platform database does not have the recipient information needed to complete the online order (e.g., the destination address), the e-commerce platform can take certain steps to acquire the information from the recipient. This might arise where the recipient does not have an account with the e-commerce platform or they have never needed to submit their destination address to complete a transaction. After determining the seeded query failed or that it returned insufficient recipient information, the e-commerce platform can send a request to the recipient (using either the info provided by the buyer or any info about the recipient that does exist on the platform) prompting the recipient to input the requested recipient information (e.g., destination address). The request may be distributed via one or more channels (e.g., email, text, social media) according to the stored recipient information or the recipient information received from the buyer. The request may additionally or alternatively prompt the user to set up an account and/or indicate whether to permit the gift from the buyer.

The e-commerce platform can allow the recipient to enter information about themself and/or setup configuration preferences related to gifts. The e-commerce platform references the recipient inputs and configurations to process gifts directed to the recipient. The recipient can indicate specific buyers or categories of buyers permitted to send gifts to the recipient. These indicators can be entered by the recipient prior to the buyer's online order or in response to a directed request for permission, which is sent to the recipient when the buyer attempts to complete the online order.

The buyer app utilizes the token in place of the recipient's destination address, and the merchant can utilize the token to request the destination address from the e-commerce platform during processing of the online order. When the merchant processes the order and needs to determine where to ship the order, the merchant can decode the token or request information from the e-commerce platform using the token. The e-commerce platform will present the destination address to the merchant.

Illustrative Commerce Platform

In some embodiments, the methods disclosed herein may be performed on or in association with a commerce platform, such as an e-commerce platform. Therefore, an example of a commerce platform will be described by way of introduction.

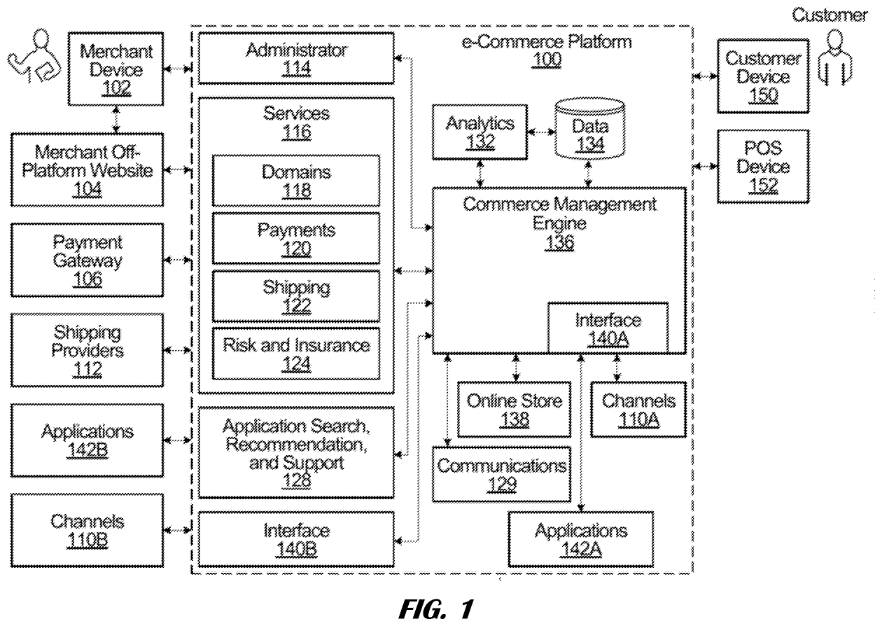

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their web site through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

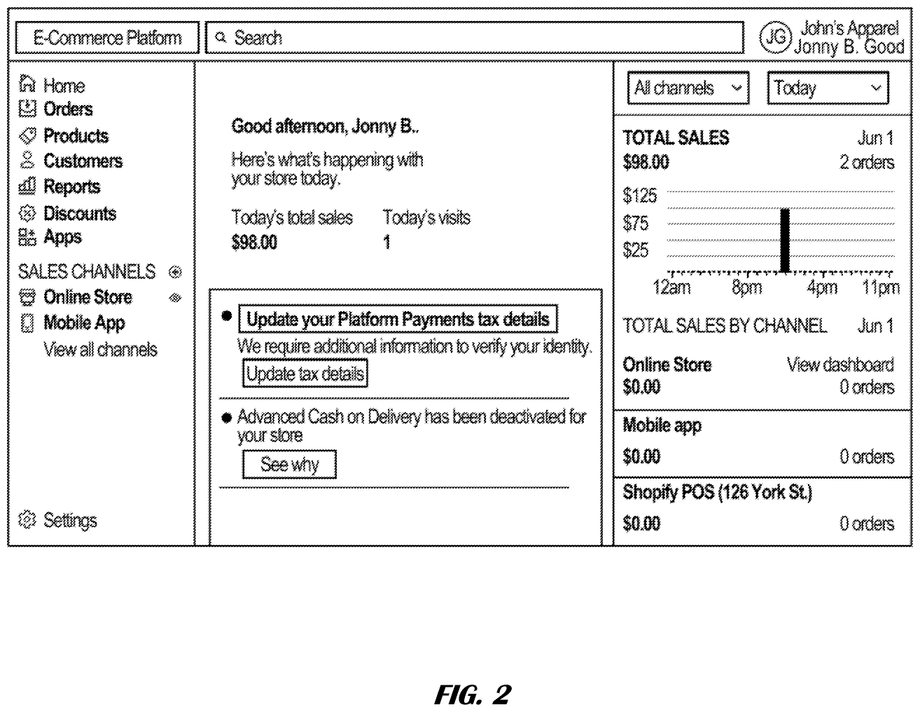

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g., via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if the customer has never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Networked Components of Illustrative System

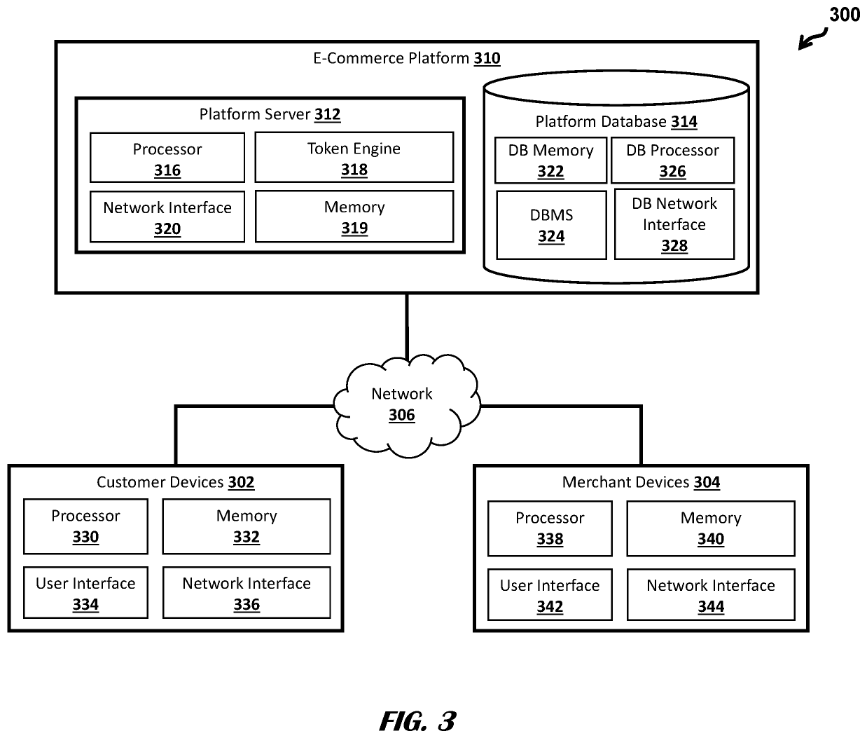

FIG. 3 shows components of a system 300 according to an embodiment. The system 300 includes customer devices 302, merchant devices 304, and e-commerce platform 310, each of which may communicate with another via one or more networks 306. The system 300 is described and shown in FIG. 3 as having one of each component for ease of description and understanding of an example. It should, however, be appreciated that embodiments may include any number of the components described herein. It should be further appreciated that embodiments may comprise additional or alternative components, or may omit certain components, and still fall within the scope of this disclosure.

Network 306

The network 306 may include any number of networks, which may be public and/or private networks. The network 306 may comprise hardware and software components implementing various network and/or telecommunications protocols facilitating communications between various devices, which may include devices of the system 300 or any number of additional or alternative devices not shown in FIG. 3. The network 306 may be implemented as a cellular network, a Wi-Fi network, or other wired local area network (LAN) or wireless LAN, a WiMAX network or other wireless or wired wide area network (WAN), and the like. The network 306 may also communicate with external servers of other external services coupled to the network 306, such as servers hosting a social media platform or a banking platform. Notably, the network 306 may be considered a computer network.

The network 306 may include any number of security devices or logical arrangements (e.g., firewalls, proxy servers, DMZs) to monitor or otherwise manage web traffic to the e-commerce platform 310. Security devices may be configured to analyze, accept, or reject incoming web requests from customer devices 302 or merchant devices 304. In some embodiments, a security device may be a physical device (e.g., a firewall). A security device may be a software application (e.g., Web Application Firewall (WAF)) that is hosted on, or otherwise integrated into, another computing device of the system 300. The security devices monitoring web traffic are associated with, and administered by, the e-commerce platform 310.

Customer Devices 302 and Merchant Devices 304

Merchant devices 304 are electronic devices associated with merchant accounts of the e-commerce platform 310. Customer devices 302 are electronic devices associated with users who are not operating as merchants, such as end-point customers or potential customers, who are visiting online stores of merchants on the e-commerce platform 310. In some circumstances, a customer device 302 and a merchant device 304 can be the same device, as merchants may sometimes navigate webpages for online stores of the e-commerce platform 310 when the merchant is acting in the capacity of a customer. As such, a customer device 302 may sometimes act as a merchant device 304 while at other times act as the customer devices 302. In an example, a merchant may use the same device to both configure the merchant settings for the online store (or other configuration settings) and then browse the online stores of other merchants on the e-commerce platform 310.

The customer device 302 may be a mobile phone, tablet, laptop or computer owned and/or used by a customer. The customer device 302 includes a customer processor 330, customer memory 332, customer user interface 334, and customer network interface 336. An example of a customer user interface 334 is a display screen (which may be a touch screen), a gesture recognition system, a keyboard, a stylus, and/or a mouse. The customer network interface 336 is provided for communicating over the network 306. The structure of the customer network interface 336 will depend on how the customer device 302 interfaces with the network 306. For example, if the customer device 302 is a mobile phone or tablet, the customer network interface 336 may include a transmitter/receiver with an antenna to send and receive wireless transmissions to/from the network 306. If the customer device 302 is a personal computer connected to the network 306 with a network cable, the customer network interface 336 may include, for example, a network interface card (NIC), a computer port, and/or a network socket. The customer processor 330 directly performs or instructs all of the operations performed by the customer device 302. Non-limiting examples of these operations include processing user inputs received from the customer user interface 334, preparing information for transmission over the network 306, processing data received over the network 306, and instructing a display screen to display information. The customer processor 330 may be implemented by one or more processors that execute instructions stored in the customer memory 332. Alternatively, some or all of the customer processor 330 may be implemented using dedicated circuitry, such as an ASIC, a GPU, or a programmed FPGA.

The merchant device 304 may be a mobile phone, tablet, laptop, or computer used by a merchant. The merchant device 304 includes a merchant processor 338, merchant memory 340, a merchant user interface 342, and a merchant network interface 344. An example of a merchant user interface 342 is a display screen (which may be a touch screen), a keyboard, a gesture recognition system, a stylus, and/or a mouse. The merchant network interface 344 is provided for communicating over the network 306. The structure of the merchant network interface 344 will depend on how the merchant device 304 interfaces with the network 306. For example, if the merchant device 304 is a mobile phone or tablet, the merchant network interface 344 may include a transmitter/receiver with an antenna to send and receive wireless transmissions to/from the network 306. If the merchant device 304 is a personal computer connected to the network 306 with a network cable, the merchant network interface 344 may include, for example, a NIC, a computer port, and/or a network socket. The merchant processor 338 directly performs or instructs all of the operations performed by the merchant device 304. Examples of these operations include processing user inputs received from the merchant user interface 342, preparing information for transmission over the network 306, processing data received over the network 306, and instructing a display screen to display information. The merchant processor 338 may be implemented by one or more processors that execute instructions stored in the merchant memory 340. Alternatively, some or all of the merchant processor 338 may be implemented using dedicated circuitry, such as an ASIC, a GPU, or a programmed FPGA.

The merchant device 304 includes software and hardware components enabling Internet or other forms of networked communication with components of the system 300 (e.g., platform server 312, customer device 302), as well as enabling the merchant device 304 to perform the various functions described herein. For example, the merchant device 304 can operate as a webserver, executing webserver software (e.g., Apache®, Microsoft IIS®) to generate and present merchant webpages or other merchant information to the customer device 302. These are merely examples and are not intended to be limiting as to the potential arrangements or functions of the merchant device 304.

The customer device 302 executes a buyer application (“app”) associated with the e-commerce platform 310. The buyer app is a native software application of the customer device 302 including machine-readable executable instructions installed in the customer memory 332 of the customer device 302. The buyer app facilitates interactions between the customer-user (i.e., the buyer), the customer device 302, the merchant device 304, and the merchant store. The buyer app (or other application) connects the customer device 302 to the platform server 312 and the merchant webpage using one or more IP Addresses obtained by translating a domain name The buyer operates the buyer app to navigate various merchant stores available on the e-commerce platform 310, review and consider products offered by the merchant stores, and initiate a purchase order for a desired product.

When the customer device 302 visits an online store of a merchant, the platform server 312 of the e-commerce platform 310 serves a catalog of available products offered by the merchant, displayed in the customer user interface 334 of the buyer app, such as a graphical user interface (GUI). The customer user interface 334 of the buyer app can also display a webpage hosted by the merchant device 304 via an embedded browser, whereby the buyer app invokes the native browser application of the customer device 302. The buyer app or other application (e.g., browser) of the customer device 302 transmits a request to the e-commerce platform 310 for the product information or webpage of the online store of the merchant. The platform server 312 receives the request for the webpage from the buyer app and, in return, the platform server 312 and/or the merchant device 304 transmits the requested product information or product webpage of the merchant's online store for display on the customer user interface 334 of the buyer app.

In operation, the buyer app displays the merchant store hosted by the platform server 312 in the customer user interface 334. The buyer selects the particular merchant of interest by entering a merchant selection input into the customer user interface 334, thereby instructing the buyer app to transmit a request for the merchant information from the platform server 312 and/or the merchant device 304. When the buyer selects the particular product of interest by entering a product selection input into the customer user interface 334, the buyer app transmits a request for the product information from the platform server 312 and/or the merchant device 304. The merchant device 304 transmits the product information to the customer device 302 and the buyer app displays the product information on a customer user interface 334 of the buyer app.

The buyer app communicates with the e-commerce platform 310 and the customer device 302 and provides the token to the buyer app to submit with the online order. Though the buyer app performs the various processes described herein, the buyer app need not be the same buyer app that browses and displays the content of the merchant's online store. The customer device 302 may execute one or more software applications that function as the buyer app. When the customer device 302 executes more than one software application as the buyer app, the software applications can each perform some or all of the buyer app's functions. For example, the buyer app communicates with the e-commerce platform 310 and the customer device 302, and presents the token in fields of the buyer app and/or a browser extension, where the token is inputted directly to the fields in checkout. The merchant device 304 executes software applications that are likewise compatible with each software application of the buyer app and configured to perform the data processing and verification (e.g., address verification) for completing the transaction as described herein.

The buyer may initiate a purchase order for the product by selecting certain elements (e.g., buttons) of the customer user interface 334, thereby instructing the buyer app and the customer device 302 to transmit a purchase transaction request to the merchant device 304. The merchant device 304 returns (to the buyer app) instructions for displaying an interactive purchase order form on the customer user interface 334. The buyer enters purchase order information (e.g., billing information, recipient information) into the fields (e.g., credit card number, buyer name, recipient name) of the purchase order form, then actuates a GUI element (e.g., button) instructing the buyer app to submit the purchase order. The buyer app transmits the purchase order (and entered purchase order information) to the customer device 302 and to the platform server 312, which updates various records of the platform database 314, such as a transaction data record, a buyer data record, a merchant data record.

The purchase order form typically includes data fields for entering the shipping information (e.g., destination address) informing the merchant where to deliver the product. Sometimes, however, the buyer does not know the destination address for the intended recipient of the gift, and so the buyer cannot complete the purchase order form. The customer user interface 334 of the buyer app includes a gift indicator element, allowing the buyer to forgo the requirement of entering the destination address. The buyer can enter an input (via the customer user interface 334) selecting the gift indicator, which indicates to the various devices of the system 300 the intended purchase transaction is for a gift. In response, the devices of the system 300 adjust or perform certain operations to facilitate the transaction without the destination address for the recipient.

The customer device 302 includes any number of software applications that have data entries containing recipient information, such as a contacts app, in order to generate a seeded query for the e-commerce platform 310. The contacts app accesses a location in the customer memory 332. When the buyer selects the gift indicator, the buyer app instructs the contacts app to query the customer memory 332 using information entered into the purchase order form or other aspect of the customer user interface 334. For example, when the buyer enters the first name and last name of the recipient into the purchase order, the buyer app instructs the contacts app to query for data entries of potential recipients. In some cases, the buyer app presents multiple candidates to the buyer via the customer user interface 334, allowing the buyer to select the intended recipient. The buyer app extracts certain recipient information (e.g., first name, last name, email address, telephone number) from the identified data entries of the customer memory 332 and generates the seeded query based upon the extracted recipient information. The customer device 302 then transmits to the platform server 312 the seeded query (containing the extracted recipient information) and a request for the token corresponding to the destination address for the recipient.

The e-commerce platform 310 performs various operations for generating the token and, if permitted, returns the token to customer device 302. To maintain the recipient's privacy, each of the buyer, the buyer app, and the customer device 302 are inhibited from accessing (or otherwise reverse engineering) the destination address for any other private information about the recipient. The platform server 312 generates the token based upon any number of data fields for the recipient, merchant, buyer, and/or transaction, by applying one or more obfuscation algorithms (e.g., encryption, hashing) on these data values, thereby generating a new alphanumeric string as the token. As will be explained, the token is later used by the platform server 312 to retrieve and provide the destination address for the recipient to the intended merchant, without exposing any personal information of the recipient.

The customer interface 334 displays a message or other representation that the buyer app received the token and that the purchase order is ready for submission. For example, the data fields for the entering the shipping information (e.g., destination address for the recipient) may be blurred, deemphasized, or removed from the customer user interface 334. As another example, the buyer app fills the purchase order fields corresponding to the shipping information with a visual display of the token or representation, which could include the alphanumeric string of the token, a blurred or symbolic (e.g., shapes, symbols) representation of the token. The buyer app may employ other methods for hiding the recipient's information (e.g., displaying the received recipient information from the original query and an indication that an address match has been made).

E-Commerce Platform 310

The e-commerce platform 310 is a computing system infrastructure owned and managed by an e-commerce service and, in some embodiments, may be the same as or similar to that described with reference to FIG. 1, though this need not be the case. The e-commerce platform 310 includes electronic hardware and software components capable of performing various processes, tasks, and functions of the e-commerce platform 310. For instance, the computing infrastructure of the e-commerce platform 310 may comprise one or more platform networks (not shown) interconnecting the components of the e-commerce platform 310. The platform networks may comprise one or more public and/or private networks and include any number of hardware and/or software components capable of hosting and managing the networked communication among devices of the e-commerce platform 310.

The e-commerce platform 310 comprises the platform server 312 and the platform database 314, though embodiments may include additional or alternative components capable of performing the operations described herein. The components of the e-commerce platform 310 may be embodied in separate computing devices interconnected via one or more public and/or private internal networks, while some components of the e-commerce platform 310 may be integrated into a single device. For instance, the platform server 312 could host the platform database 314, even though such integration is not shown in FIG. 3. Furthermore, the e-commerce platform 310 may include any number of platform servers 312 (described further below) configured to serve various functions of the e-commerce platform 310. Moreover, the e-commerce platform 310 is shown and described as having only one platform server 312 performing each of the various functions of the e-commerce service for ease of discussion. It should, however, be appreciated that FIG. 3 is merely illustrative and that embodiments are not limited to the description of system 300 or what is shown in FIG. 3. The software and hardware of the platform server 312 may be integrated into a single distinct physical device (e.g., a single platform server 312) or may be distributed across multiple devices (e.g., multiple platform servers 312). For example, some operations may be executed on a first computing device while other operations may be executed on a second computing device, such that the functions of the platform server 312 are distributed among the various computing devices. In some implementations, the platform server 312 may be a virtual machine (VM) that is virtualized and hosted on computing hardware configured to host any number of VMs.

Platform Database 314

The platform database 314 stores and manages data records concerning various aspects of the e-commerce platform 310, including information about, for example, buyers, merchants, recipients, transactions, electronic devices, merchant offerings (e.g., products, inventory, services), various metrics and statistics, machine-learning models, merchant pages hosting merchant stores, and other types of information related to the e-commerce platform 310. The platform database 314 is hosted on any number of computing devices having a processor (sometimes referred to as a database (DB) processor 326) and non-transitory machine-readable memory configured to operate as a DB memory 322, and capable of performing the various processes and tasks described herein. For example, one or more platform servers 312 may host some or all aspects of the platform database 314.

The computing device hosting the platform database 314 may further include a DB network interface 328 for communicating via platform networks of the e-commerce platform 310. The structure of the DB network interface 328 will depend on how the hardware of the platform database 314 interfaces with other components of the e-commerce platform 310. For example, the platform database 314 may be connected to the platform network with a network cable, the DB network interface 328 may include, for example, a NIC, a computer port, and/or a network socket. The DB processor 326 directly performs or instructs all of the operations performed by the platform database 314. Non-limiting examples of such operations include processing queries or updates received from platform servers 312, customer devices 302, and/or merchant devices 304; preparing information for transmission via the platform network and/or the external networks 306; and processing data received via the platform network and/or the external networks 306. The DB processor 326 may be implemented by one or more processors that execute instructions stored in the DB memory 322 or other non-transitory storage medium. Alternatively, some or all of the DB processor 322 may be implemented using dedicated circuitry, such as an ASIC, a GPU, or a programmed FPGA.

Moreover, a computing device hosting the platform database 314 may include and execute database management system (DBMS 324) software, though DBMS 324 is not required in every configuration. The platform database 314 can be a single, integrated database structure or may be distributed into any number of database structures that are configured for some particular types of data needed by the e-commerce platform 310. For example, a first database could store user credentials and be accessed for authentication purposes, and a second database could store raw or compiled machine-readable software code (e.g., HTML, JavaScript) for webpages such that the DB memory 322 is configured to store information for hosting webpages. The DB memory 322 of the platform database 314 may contain the recipient data records, transaction data records, and/or merchant data records. The platform server 312 may issue queries to the platform database 314 and updates based upon, for example, merchant transaction records or new user records (e.g., new buyer, new recipient) of the e-commerce platform 310. The platform database 314 further stores various types of data received from customer devices 302 or merchant devices 304.

Platform Server 312

The platform server 312 may be any computing device that comprises a server processor 316 and non-transitory machine-readable storage media (e.g., server memory 319) and that is capable of executing the software for one or more functions, such as a token engine 318. In some cases, the server memory 319 may store or otherwise contain the computer-executable software instructions, such as the token engine 318. The software and hardware components of the platform server 312 enable the platform server 312 to perform various operations that serve particular functions of the e-commerce platform 310. For example, the platform server 312 that serves as a web server may execute various types of web server software (e.g., Apache®, Microsoft IIS®). As another example, the platform server 312 that serves as a security server may execute software for monitoring and analyzing web traffic between customer devices 302, merchant devices 304, and the e-commerce platform 310. These are merely examples and are not intended to be limiting as to the potential arrangements or functions of the platform servers 312. Non-limiting examples of the platform server 312 may include desktop computers, laptop computers, and tablet devices, among others.

The platform server 312 executes the token engine 318, which includes software executable instructions that executes various processes and tasks described herein. As mentioned, the platform database 314 includes data records associated with transactions and various types of users (e.g., buyers, recipients). The token engine 318 (and/or other component of the platform server 312) references such data records to generate the token, in response to the platform server 312 receiving the seeded query containing certain recipient information and the request for the token from the customer device 302. In operation, the token engine 318 receives the seeded query from the buyer app of the customer device 302 and queries the data records of the platform database 314 to identify any data records with data fields matching the seeded query. For instance, the recipient information of the seeded query received from the customer device 302 could include the recipient's email address, first name, and last name. The platform server 312 retrieves the recipient data record containing one or more data fields matching the recipient information (of the seeded query received from the customer device 302) and thus includes the destination address for the intended recipient.

The token engine 318 generates the token using some or all of the recipient information extracted from the recipient data record (retrieved according to the seeded query). The token engine 318 extracts certain portions of the recipient information from the recipient data record of the platform database 314, including a unique recipient identifier associated with the destination address for the recipient. The token engine 318 applies the one or more obfuscation algorithms (e.g., using a hash function that is not easily inverted such as, for example, a cryptographic hash like SHA-256, MD5 message-digest algorithm, SHA-0, SHA-1, and asymmetric key encryption algorithms) to the extracted portions of the recipient data record (e.g., unique recipient identifier). The platform server 312 stores the token into the server memory 319 and transmits the token to the customer device 302. In some cases, the token engine 318 uses a unique transaction identifier or other value to generate the token, such that the token is for a one-time use and invalid or otherwise not mapped to any particular data record after the transaction or session is terminated. Additionally or alternatively, token engine 318 generates the token using a unique merchant identifier, thereby associating the merchant with the transaction. When the platform server 312 later receives the token from the merchant device 304, the platform server 312 can derive the merchant identifier from the token to confirm that the token was received from the expected merchant.

The token engine 318 can perform various processes to confirm or verify whether to generate the token as requested according to additional recipient information and/or recipient configurations. These processes confirm, for example, the identity of the intended recipient, the recipient identified in the query is correct, and/or whether the intended recipient is willing to accept gifts from the buyer. In some implementations, the additional recipient information includes a relationship indicator. For example, the relationship indicator may indicate that the buyer app successfully identified and extracted the initial recipient information (of the seeded query) from the customer memory 332, suggesting the recipient has at least some level of connection with the buyer. The token engine 318 detects this relationship indicator and generates the token accordingly.

Additionally or alternatively, the buyer app accesses a block list and/or accept list of possible buyers (gift-givers) from who the recipient would deny and/or accept gifts. For example, the recipient may accept gifts from any buyer, except those included on the recipient's block list. In another example, the recipient may accept gifts only from buyers including on the recipient's accept list, who could or could not have some relationship to the contact list of the buyer or the recipient (e.g., any buyer contact or recipient contact permitted by default). The recipient can indicate a more general configuration or willingness to receive or not receive gifts from any buyer. The recipient may, additionally or alternatively, input a configuration to be notified and accept/reject gift requests, or the recipient can indicate to only accept gifts from the recipient's established connections (stored in the recipient profile of the platform database 314), which may be inputted by the recipient at a website of the e-commerce platform 310 or synced with the contacts stored on the recipient's device to the recipient's account and profile on the e-commerce platform 310.

Additionally or alternatively, the token engine 318 generates an interactive confirmation prompt for display at the customer user interface 334. The confirmation prompt includes one or more prompts or questions challenging whether the buyer knows the recipient. In some implementations, a recipient configuration may include, for example, presenting a security question to the buyer, as a means of filtering (e.g., permit/deny) buyers permitted to send gifts to the recipient. This filtering configuration may be stored in the account profile of the recipient in the platform database 314. This beneficially provides a way for the recipient to prearrange with buyers and the e-commerce platform 310 a manner for establishing a relationship and/or signal an expectation of the gift. The token engine 318 receives and compares inputs received from the buyer against the data fields of the recipient data record. The token engine 318 generates the token when the responses from the buyer app satisfy a threshold number of correct answers (as compared to the recipient data record). Similarly, when the platform server 312 identifies the recipient data records of multiple candidates, the platform server 312 generates and provides the confirmation prompt containing the set of candidates to the customer device 302. The buyer app displays the confirmation prompt to the buyer, allowing the buyer to select the buyer's intended recipient. The platform server 312 generates the token according to the recipient selected from the set of candidates.

In some implementations, the token engine 318 reviews recipient configurations, stored in the recipient data record or other storage location, to verify whether the buyer is permitted to send the gift to the recipient. The recipient configurations indicate whether the recipient is willing to receive gifts from any buyers or from the particular buyer. The platform server 312 receives the recipient configurations of the recipient from the customer device 302 and stores the configurations into the recipient data record. In some circumstances, the platform server 312 does not identify an existing recipient data record. For instance, the recipient may not be a registered user of the e-commerce platform 310 or never previously received gifts through the e-commerce platform 310. In these circumstances, the platform server can send a notification to the recipient through one or more communication channels (e.g., short message service (SMS) text message, email) according to the recipient information received from the customer device 302. The notification requests the recipient to input the recipient configurations indicating whether the recipient is willing to accept the intended gift from the buyer. The platform server 312 receives and stores the recipient configurations into the platform database 314. The token engine 318 generates the token in response to determining that the recipient configurations permit the buyer to send the gift.

The merchant device 304 detects the token when the merchant device 304 receives the purchase order from the customer device 302 and/or receives the gift indicator. The merchant device 304, in turn, transmits a request for the destination address and the token to the server. When the platform server 312 receives the request for the destination address and the token from the merchant device 304, the platform server 312 applies certain obfuscation algorithms to derive the unique recipient identifier (or other identifier) for retrieving the destination address for the recipient. Using the token, the platform server 312 retrieves the destination address for the recipient from the server memory 319 or the DB memory 322 and then transmits the destination address to the merchant device 304. The merchant device 304 receives the destination address for the recipient and services the intended transaction according to the information submitted with the online order and the destination address.

Illustrative Methods of Operation

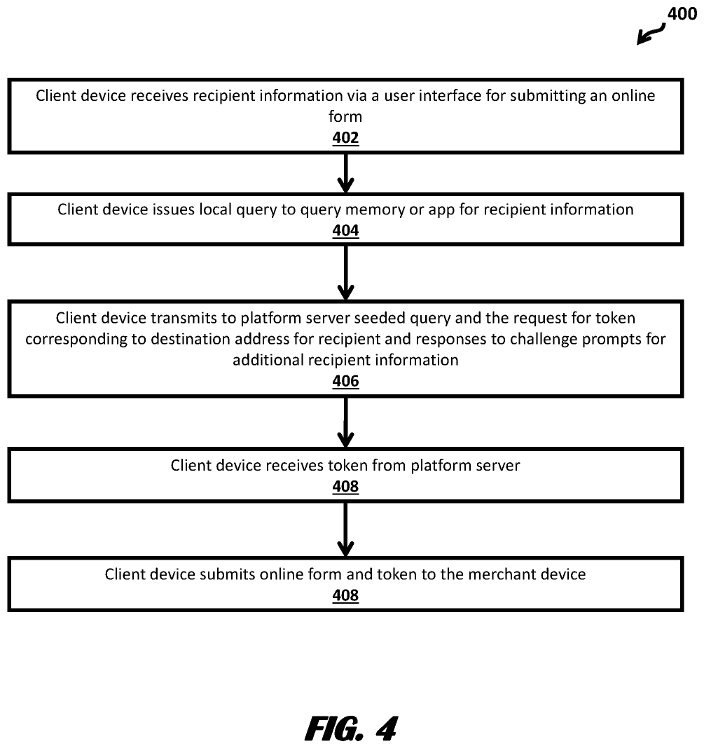

FIG. 4 shows steps of executing a method 400 by an end-user client device, according to an embodiment. The client device communicates with a server (or other computing device) of an e-commerce platform and a merchant server, and executes various software components or other machine-readable instructions (e.g., buyer app) that instruct the client device to execute the steps of the method 400. The steps of the method 400 are described as being executed by the client device (e.g., customer device 302), the merchant server (e.g., merchant device 304), and the server (e.g., platform server 312) of the e-commerce platform (e.g., e-commerce platform 310), but any number of additional or alternative devices may execute some or all of the steps and still fall within the scope of this disclosure. Although the client device is described as implementing the buyer app, this is merely for ease of understanding and description, and the client device can execute any number software applications when executing the method 400.

In step 402, the client device receives recipient information for submitting an online form via a customer user interface, such as a graphical user interface (GUI) presented by a buyer app or other software application of the client device. When navigating to a merchant store, the client device transmits to the server and/or the merchant store an access request for the merchant store. The request instructs the merchant server to return and display information about a product offered by the merchant to the user via the GUI of the client device. The GUI further displays an online order form (or other type of data input interface) allowing the user and the client device to submit purchase and shipping information to the merchant server and the merchant.

When the user is purchasing the product as a gift on behalf of a recipient, the user can select a gift indicator of the order form presented by the GUI. The gift indicator instructs the merchant server to disable data validation requirements of the online form related to the destination address, such that the merchant server no longer requires the destination address to complete the form and the user is not required to expressly enter the destination address. The gift indicator further indicates to the merchant server that, in lieu of the destination address, the client device will be submitting a token corresponding to the destination address with the online form.

In step 404, the client device queries a memory location accessible to the client device for information about the recipient. The memory location may reside locally as a component of the client device and is accessible to one or more applications, such as a contacts app of the client device. Additionally or alternatively, the memory location resides on a device of a cloud-based service accessible to the applications of the client device. In operation, the buyer app receives the gift indicator (or other type of instruction) inputted by the user, then the buyer app constructs a local memory using some or all of the buyer-entered recipient information. The buyer app issues the local query to the contacts app (or other application) of the client device and instructs the contacts app to query the memory location according to the recipient information (of the local query) as entered by the buyer into the purchase order form (or other interface) presented on the buyer app.

The contacts app and/or the memory location returns the recipient information, identified according to the query, to the buyer app. The recipient information returned to the buyer app includes one or more data entries or records that match some or all of the recipient information of the query. As an example, the buyer app constructs the local memory query based upon using the entered recipient information, which includes, for example, the first and last name of the recipient as entered by the buyer. Using the local query, the buyer app queries the contacts app for a contact data entry having data fields (e.g., the first name and the last name) satisfying the local query. The contacts app returns the entire contact entry or certain data fields of the contact entry (e.g., recipient email address) to the buyer app. The buyer app extracts the data fields of the identified contact entry and generates a seeded query using the data fields containing the recipient information extracted from the identified contact entry.

In some cases, multiple contact entries contain data fields matching some or all of the query, causing the contacts app to return the multiple contact entries to the buyer app. In these cases, the buyer app requests the user confirm which of the contact entries is associated with the intended recipient. In operation, the client device presents a confirmation prompt, via the GUI of the buyer app, displaying the returned candidate contact entries. The buyer selects the particular contact entry for the intended recipient, which the buyer app identifies as the contact entry for continuing the process 400. The buyer app extracts the data fields of the selected contact entry and generates the seeded query using the data fields containing the recipient information extracted from the selected contact entry.

If the server does not identify a match between the seeded query and the database, then the server can transmit a notification to the intended recipient, requesting the recipient to input information and/or to permit the gift. For instance, the recipient may not be a registered user of the e-commerce platform or the recipient never received purchases or gifts through the e-commerce platform, so the destination address for the recipient is not in the database. In these circumstances, the server can send the notification to the recipient through one or more communication channels (e.g., short message service (SMS) text message, email) according to the recipient information received in the seeded query from the client device. The notification requests the recipient to input the recipient configurations indicating, for example, the destination address for the recipient, and that the recipient is willing/unwilling to accept the intended gift from any buyer or the particular buyer. The server receives and stores the recipient configurations into the database. The server generates proceeds with the process 400 in response to determining that the recipient configurations permit the buyer to send the gift.

In step 406, the client device transmits the seeded query containing the recipient information and a request for a token corresponding to the destination address for the recipient. The buyer app extracts the data fields from the particular contact entry, generates the seeded query containing the recipient information extracted from the contact entry, and sends the seeded query to the platform server. The recipient information of the seeded query includes the data fields used by the platform server when the platform server generates the token corresponding to the destination address for the recipient.

In some implementations, the server performs one or more additional confirmation checks to determine that the buyer has at least some relationship with the recipient and/or to confirm the buyer's intended recipient (when the server identified multiple candidates from the platform database based upon the seeded query). The buyer app may submit (with the request for the token) a relationship indicator that the buyer app identified the recipient information (of the seeded query) in the client device memory, which suggests that the buyer has at least some connection with the recipient. This relationship indicator could suffice as additional recipient information that satisfies the additional confirmation check.

Additionally or alternatively, the server may generate a challenge prompt to gather the additional information from the buyer. The server then transmits the challenge prompt to the buyer app for display to the buyer via the GUI of the buyer app. The challenge prompt includes one or more GUI interface items (e.g., text, text input field, button) prompting the buyer to input additional recipient information. For example, the server can extract recipient information from a platform database record of the recipient, and generate the challenge prompt containing one or more questions prompting the buyer to provide responses to those questions. The server can receive the additional recipient information in the buyer responses from the buyer app and compare the buyer's responses against the expected responses, which are based on the information extracted from the platform record. The additional recipient information received in the responses can confirm, for example, that the buyer has more knowledge about the recipient and/or the intended recipient when the server identifies multiple candidate recipients in the platform database. In addition, the set of candidates can be limited according to the additional recipient information received from the buyer, while protecting the privacy of the candidates who the buyer does not know. For instance, where the server identifies several candidates, the server can use the additional recipient information received in the challenge prompt (e.g., the city where the intended recipient resides) to confirm the intended recipient.

In step 408, the client device receives the token from the server (assuming the server permits the transaction process 400 to proceed). The buyer app detects that the token arrived from the server and determines that the online form is complete and ready for submission. As mentioned, the token is a representation of the destination address, generated by the server using one or more obfuscation algorithms (e.g., encryption algorithm, hash algorithm) and certain recipient information (e.g., unique recipient identifier, destination address for the recipient). The obfuscation algorithm used to generate the token renders the recipient information of the token inaccessible to the buyer and the buyer app.

Even though neither the buyer app nor the client device can access the destination address for the recipient, which would ordinarily inhibit submission of the entry form, the process 400 can still proceed. The buyer app and the merchant device are configured to permit the transaction to proceed by suspending ordinary data validation rules requiring the buyer to enter the destination address directly into the form. The buyer app and the merchant server recognize the token as sufficient input for completing the order form. Additionally or alternatively, the merchant server decodes the token before finalizing the order to verify the token is valid and authentic and, in some cases, to extract additional information about the transaction (e.g., shipping and tax costs).

In step 410, the client device submits the purchase order and the token to the merchant server. After the client device receives the token, the buyer app detects the token and determines that the buyer app is ready to submit the purchase order to the merchant server. The GUI of the buyer app may generate and display a visual representation that the token and the form are ready for submission and/or were successfully sent to the merchant device. For example, the order form GUI may display text indicating to the buyer that the token is ready for submission and remove or deemphasize the text fields for entering the shipping address or other recipient information. In other examples, the GUI of the buyer app displays a blurred or hidden version of the alphanumeric characters of the token, presents shapes or symbols to replace of characters in the fields of the purchase order form, or other methods for hiding the recipient's information (e.g., displaying certain recipient information of the local query and/or seeded query; displaying an indication that the server identified a match between the seeded query and at least one data record in a platform database).

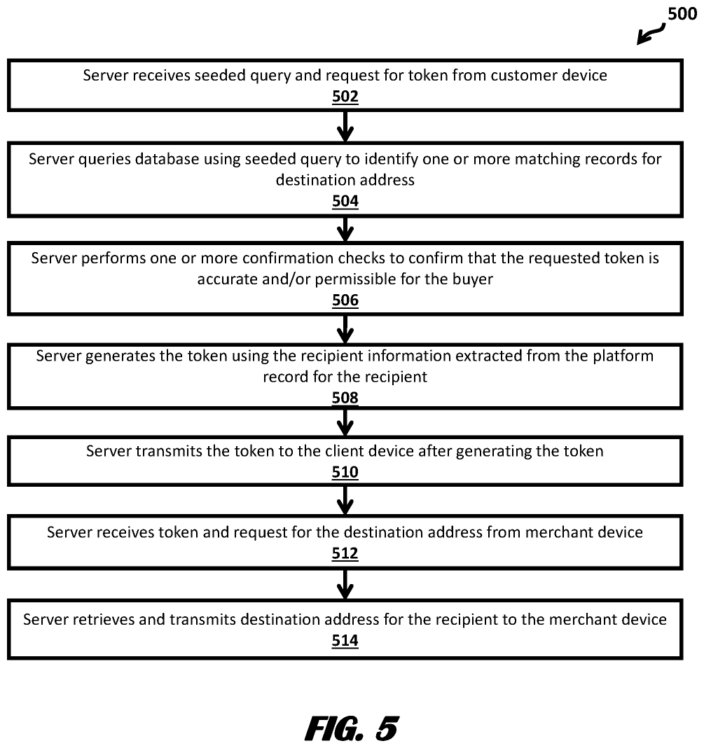

FIG. 5 shows steps of executing a method 500 by a server of an e-commerce platform, according to an embodiment. The server communicates with a client device and a merchant server, and executes various software components or other machine-readable instructions (e.g., token engine) that instruct the server to execute the steps of the method 500. The steps of the method 500 are described as being executed by the server (e.g., platform server 312), the merchant server (e.g., merchant device 304), and the client device (e.g., customer device 302), but any number of additional or alternative devices may execute some or all of the steps and still fall within the scope of this disclosure. Although the server is described as implementing the token engine, this is merely for ease of understanding and description, and the server can execute any number software applications when executing the method 500.

In step 502, the server receives a seeded query containing initial recipient information and a request for a token from the client device. The client enters certain recipient information into a GUI of the buyer app, instructing the buyer app to query contact data entries stored in the memory of the client device. The buyer app transmits the results of the query to the server. The recipient information of the seeded query includes, for example, a first and last name of the recipient and an email address of the recipient.

In step 504, the server queries a database (e.g., platform database 314) according to the recipient information of the seeded query. The server executes the seeded query to identify one or more data records with information matching the recipient information of the seeded query received from the server. The database may include transaction data records (for prior or ongoing transactions), recipient data records (for registered users with the e-commerce platform), or other types of data records containing recipient information. The server then proceeds forward with the process 500 based on the results of the seeded query.

In step 506, the server performs one or more confirmation checks to confirm that the requested token is accurate and/or permissible for the buyer. The server transmits one or more confirmation prompts to the client device for display at the GUI of the buyer app, which the server employs to confirm the intended recipient from multiple candidates, and/or to request additional recipient information from the buyer, which the server analyzes to confirm that the buyer has some level of relationship with the recipient. The server can also query recipient configurations to determine whether the recipient previously indicated whether any buyers (or the particular buyer) may send gifts to the recipient.

In some circumstances, the server identifies data records for multiple candidate recipients (in step 504) and must confirm with the buyer which candidate recipient is the intended recipient. The server generates and sends a confirmation prompt to the buyer app containing the set of candidate recipients. The server proceeds with the method 500 using the recipient data record corresponding to the candidate recipient identified by the buyer.

Additionally or alternatively, the server generates a challenge prompt using data extracted from the data fields in the recipient data record. The server transmits the challenge prompt to the customer device for display by the buyer app. The server receives the buyer's challenge responses from the client device and compares the buyer's responses against the recipient data record to determine the accuracy of the buyer's responses. The server proceeds with the method 500 when the buyer's responses satisfy a threshold number of correct responses or the server ends the process when the buyer's responses fail to match to the expected responses.

The confirmation checks can include querying the recipient configurations to determine whether the recipient accepts gifts from any buyers or the particular buyer. The recipient configurations may be stored in the recipient data record of the database or transmit a notification to the recipient via one or more communication channels (e.g., email, SMS), seeking confirmation from the recipient that the recipient is willing to receive the gift from the buyer. Where the recipient configurations indicate that the gift is not permitted, the server does not generate the token and ends the method 500. The server presents to the buyer a message indicating the token cannot be generated or the transaction failed, which is displayed to the buyer via the GUI of the buyer app. Otherwise, the server continues executing the steps of the process 500.

In step 508, the server generates the token using the recipient information extracted from the platform record for the recipient, including the destination address for the recipient. The server generates the token according to one or more obfuscation algorithms that inhibit the ability of the buyer and the buyer app to access any recipient information. The token is associated with the recipient data record, a transaction data record, and/or a merchant data record and stored into non-transitory storage for later reference.

The token comprises the requisite information for the merchant device to determine the destination address for the recipient, such as a unique identifier for the recipient or other identifying information. In some cases, the server generates the token according to various arbitrary values that effectively eliminate the presence of any recipient information in the token, yet allow the server to later retrieve the recipient information on behalf of the merchant server. In such cases, the token functions as a database key associated with the recipient data record for the intended transaction. When the server later receives the token and a request for the destination address from the merchant server (as in step 512), the server can use the values of the token to fetch the recipient address from the platform database on behalf of the merchant server. In step 510, the server transmits the token to the client device after generating the token.

In step 512, the server receives the token and the request for the destination address from the merchant server. Optionally, the server performs a verification check to confirm that the token and the request were received from the intended merchant and/or executes one or more corresponding obfuscation algorithms (as in step 508) to access the information in the token used by the server to retrieve the destination address.

The verification check includes comparing a unique merchant identifier associated with the transaction against the unique merchant identifier received with the request for the destination address. The initial request for the token, received from the client device (step 502), indicates the intended gift and the merchant identifier of the merchant offering the product to be gifted. The server can compare the merchant identifier indicated by the client's request for the token against the merchant's request for the destination address to determine whether the request for the destination address was received from the appropriate merchant server. The token can be further associated with database records in the platform database (e.g., transaction record, merchant record), which the server references to confirm whether the token that the server generated for the transaction corresponds to the token received from the merchant.

Additionally or alternatively, the token applies the obfuscation algorithm to derive certain information for the server to provide the destination address to the merchant server. When generating the token (in step 508), the server applied the obfuscation algorithm on the recipient information (e.g., unique recipient information) or other information. In the current step 512, the server applies the corresponding obfuscation algorithm on the token to derive the information needed to retrieve the destination address.

In step 514, the server retrieves the destination address for the recipient from the memory of the server or other non-transitory machine-readable storage medium (e.g., database record) and transmits the destination address to the merchant server. The token includes the unique recipient identifier or other type of data value that the server can employ to reference to the memory containing the destination address. After the merchant server receives the destination address, the merchant server can then proceed with processing and servicing the transaction.

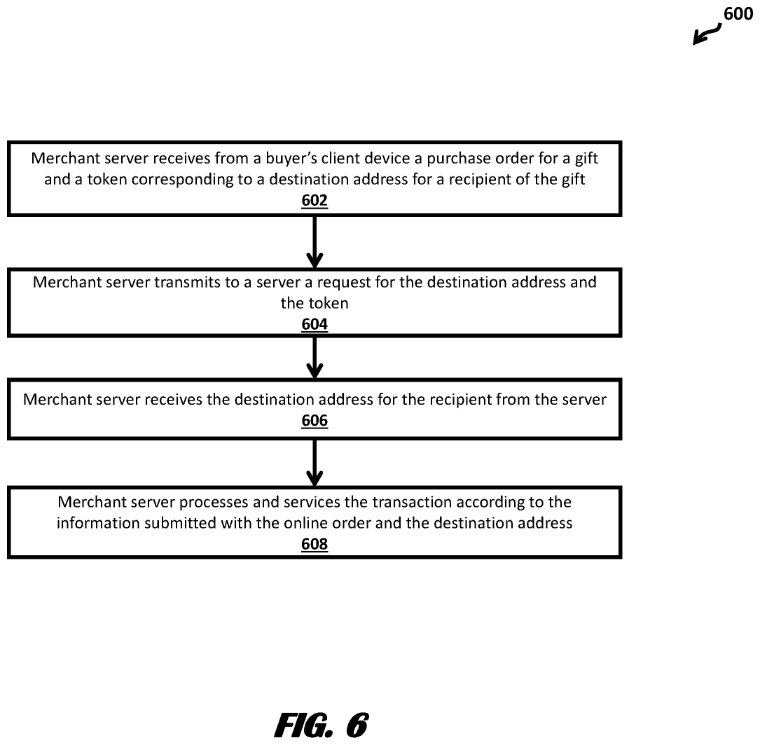

FIG. 6 shows steps of executing an illustrative method 600 by a merchant server. The merchant server communicates with a server (or other computing device) of an e-commerce platform and a client device, and executes various software components or other machine-readable instructions that instruct the merchant server to execute the steps of the method 600. The steps of the method 600 are described as being executed by the merchant server (e.g., merchant device 304), the client device (e.g., customer device 302), and the server (e.g., platform server 312) of the e-commerce platform (e.g., e-commerce platform 310), but any number of additional or alternative devices may execute some or all of the steps and still fall within the scope of this disclosure. Although the client device is described as implementing the buyer app, this is merely for ease of understanding and description, and the client device can execute any number software applications when executing the method 600.

In step 602, the merchant server receives from the client device of a buyer a purchase order for a gift and a token corresponding to a destination address for a recipient of the gift. The merchant server may detect the token when the purchase order data is received from the client device or receive a gift indicator received with the purchase order data. In step 604, based upon determining that the token is received needed, the merchant server transmits to the server a request for the destination address and the token. In step 606, the merchant server receives the destination address for the recipient from the server. In step 608, the merchant server processes and services the transaction according to the information submitted with the online order and the destination address.

In some embodiments, a computer-implemented method may include receiving, by a computer, information for a recipient of an online order associated with a merchant, the online order for delivery to the recipient. The computer may query a database using the recipient information to obtain a destination address of the recipient. The computer may generate a token corresponding to the destination address of the recipient, where the token includes an obfuscated representation of the destination address of the recipient. The computer may transmit the token to a client device for submission of the online order for delivery to the recipient, where the token is adapted to satisfy a requirement to provide the destination address for the online order. In response to the computer receiving the token from a merchant device associated with the merchant that received the order, the computer may present the destination address to the merchant device.

In some implementations, the recipient information may uniquely identify an entry corresponding to the recipient in a database accessible to the computer.

In some implementations, the token may be a one-time use token.

In some implementations, the method may include encoding, by the computer, at least a portion of the recipient information stored in the database according to one or more obfuscation algorithms.

In some implementations, the computer may generate the token based upon at least one of: a unique identifier of the recipient, a unique identifier of a buyer device, a unique identifier of a merchant device, and a unique transaction identifier.

In some implementations, in response to the computer receiving the token from the merchant device, the computer may decode the token to obtain at least a portion of the recipient information according to one or more obfuscation algorithms used to generate the token.

In some implementations, the method may further include, responsive to the computer receiving the token from the merchant device, querying, by the computer, the database using the token to obtain the destination address for the recipient.

In some implementations, the method may further include presenting, by the computer, a request for additional recipient information to a buyer device; and querying, by the computer, the database according to the additional recipient information received from the buyer device.

In some implementations, the computer may generate the token responsive to identifying the additional recipient information in the database.

In some implementations, the method may further include, responsive to the computer identifying at least a portion of the recipient information in the database, presenting, by the computer, to a buyer device a request for confirmation of the recipient.

In some implementations, the computer may generate the token responsive to receiving a response confirming the recipient from the buyer device.

In some implementations, the computer may receive the recipient information via one or more native apps of a buyer device.

In some implementations, the method may further include identifying, by the computer, a relationship between a buyer and the recipient based upon at least one of a prior purchase and an indicator from a native app of a buyer device.

In some implementations, the method may further include presenting, by the computer, to a buyer device a request for confirmation of the recipient, the request including one or more candidate recipients in the database having at least a portion of the recipient information.

In some embodiments, a system comprises a database may include a non-transitory machine-readable storage configured to store a plurality of data records containing a plurality of destination addresses and at least one processor. The at least one processor may be configured to receive information for a recipient of an online order associated with a merchant, the online order for delivery to the recipient; query the database using the recipient information to obtain a destination address of the recipient; generate a token corresponding to the destination address of the recipient, wherein the token includes an obfuscated representation of the destination address of the recipient; transmit the token to a client device for submission of the online order for delivery to the recipient, wherein the token is adapted to satisfy a requirement to provide the destination address for the online order; and responsive to receiving the token from a merchant device associated with the merchant that received the order, present the destination address to the merchant device.

In some implementations, the recipient information may uniquely identify an entry corresponding to the recipient in a database accessible to the computer.

In some implementations, the token may be a one-time use token.

In some implementations, to generate the token, the at least one processor may be further configured to encode at least a portion of the recipient information stored in the database according to one or more obfuscation algorithms. Moreover, the at least one processor may generate the token based upon at least one of: a unique identifier of the recipient, a unique identifier of a buyer device, a unique identifier of a merchant device, and a unique transaction identifier.

In some implementations, responsive to the at least one processor receiving the token from the merchant device, the at least one processor may be further configured to decode the token to obtain at least a portion of the recipient information according to one or more obfuscation algorithms used to generate the token.

In some implementations, the at least one processor may be configured to present a request for additional recipient information to a buyer device; and query the database according to the additional recipient information received from the buyer device.

In some implementations, the at least one processor may be configured to generate the token in response to identifying the additional recipient information in the database.

In some implementations, the at least one processor may be configured to: present to a buyer device a request for confirmation of the recipient in response to identifying at least a portion of the recipient information in the database; and generate the token in response to receiving a response to confirming that the recipient from the buyer device

In some implementations, the at least one processor may be configured to determine an existing relationship between a buyer and the recipient based upon at least one of a prior purchase and an indicator from a native app of a buyer device.

In some implementations, the at least one processor may be configured to present to a buyer device a request for confirmation of the recipient, the request including one or more candidate recipients in the database having at least a portion of the recipient information

In some embodiments, a machine-readable storage medium may include computer-executable instructions stored thereon that, when executed by one or more processors, cause the one or more processors to perform operations. The operations may include receiving information for a recipient of an online order associated with a merchant, the online order for delivery to the recipient; querying a database using the recipient information to obtain a destination address of the recipient; generating a token corresponding to the destination address of the recipient, wherein the token includes an obfuscated representation of the destination address of the recipient; transmitting the token to a client device for submission of the online order for delivery to the recipient, wherein the token is adapted to satisfy a requirement to provide the destination address for the online order; and responsive to the computer receiving the token from a merchant device associated with the merchant that received the order, presenting the destination address to the merchant device.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a computer, information for a recipient of an online order associated with a merchant, the online order for delivery to the recipient;
querying, by the computer, a database using the recipient information to obtain a destination address of the recipient;
generating, by the computer, a token corresponding to the destination address of the recipient, wherein the token includes an obfuscated representation of the destination address of the recipient;
transmitting, by the computer, the token to a client device for submission of the online order for delivery to the recipient, wherein the token is adapted to satisfy a requirement to provide the destination address for the online order; and
responsive to the computer receiving the token from a merchant device associated with the merchant that received the order, presenting, by the computer, the destination address to the merchant device.

2. The method of claim 1, wherein the recipient information uniquely identifies an entry corresponding to the recipient in a database accessible to the computer.

3. The method of claim 1, wherein the token is a one-time use token.

4. The method according to claim 1, wherein generating the token comprises encoding, by the computer, at least a portion of the recipient information stored in the database according to one or more obfuscation algorithms.

5. The method according to claim 4, wherein the token is generated based upon at least one of: a unique identifier of the recipient, a unique identifier of a buyer device, a unique identifier of a merchant device, and a unique transaction identifier.

6. The method according to claim 1, further comprising:
responsive to the computer receiving the token from the merchant device, decoding, by the computer, the token to obtain at least a portion of the recipient information according to one or more obfuscation algorithms used to generate the token.

7. The method according to claim 1, further comprising:
responsive to the computer receiving the token from the merchant device, querying, by the computer, the database using the token to obtain the destination address for the recipient.

8. The method according to claim 1, further comprising:
presenting, by the computer, a request for additional recipient information to a buyer device; and
querying, by the computer, the database according to the additional recipient information received from the buyer device.

9. The method according to claim 8, wherein the computer generates the token responsive to identifying the additional recipient information in the database.

10. The method according to claim 1, further comprising:
responsive to the computer identifying at least a portion of the recipient information in the database, presenting, by the computer, to a buyer device a request for confirmation of the recipient.

11. The method according to claim 10, wherein the computer generates the token responsive to receiving a response confirming the recipient from the buyer device.

12. The method according to claim 1, wherein the computer receives the recipient information via one or more native apps of a buyer device.

13. The method according to claim 1, further comprising identifying, by the computer, a relationship between a buyer and the recipient based upon at least one of a prior purchase and an indicator from a native app of a buyer device.

14. The method according to claim 1, further comprising presenting, by the computer, to a buyer device, a request for confirmation of the recipient, the request including one or more candidate recipients in the database having at least a portion of the recipient information.

15. A system comprising:
a database including non-transitory machine-readable storage configured to store a plurality of data records containing a plurality of destination addresses; and
at least one processor configured to:
receive information for a recipient of an online order associated with a merchant, the online order for delivery to the recipient;
query the database using the recipient information to obtain a destination address of the recipient;
generate a token corresponding to the destination address of the recipient, wherein the token includes an obfuscated representation of the destination address of the recipient;
transmit the token to a client device for submission of the online order for delivery to the recipient, wherein the token is adapted to satisfy a requirement to provide the destination address for the online order; and
responsive to receiving the token from a merchant device associated with the merchant that received the order, present the destination address to the merchant device.

16. The system according to claim 15, wherein the recipient information uniquely identifies an entry corresponding to the recipient in a database accessible to the computer.

17. The system according to claim 15, wherein the token is a one-time use token.

18. The system according to claim 15, wherein to generate the token, the at least one processor is further configured to encode at least a portion of the recipient information stored in the database according to one or more obfuscation algorithms, and
wherein the at least one processor generates the token based upon at least one of: a unique identifier of the recipient, a unique identifier of a buyer device, a unique identifier of a merchant device, and a unique transaction identifier.

19. The system according to claim 15, wherein responsive to the at least one processor receiving the token from the merchant device, the at least one processor is further configured to decode the token to obtain at least a portion of the recipient information according to one or more obfuscation algorithms used to generate the token.

20. The system according to claim 15, wherein the at least one processor is configured to:
present a request for additional recipient information to a buyer device; and
query the database according to the additional recipient information received from the buyer device.

21. The system according to claim 20, wherein the at least one processor is configured to generate the token in response to identifying the additional recipient information in the database.

22. The system according to claim 15, wherein the at least one processor is configured to:
present to a buyer device a request for confirmation of the recipient in response to identifying at least a portion of the recipient information in the database; and
generate the token in response to receiving a response to confirming that the recipient from the buyer device.

23. The system according to claim 15, the at least one processor is configured to determine an existing relationship between a buyer and the recipient based upon at least one of a prior purchase and an indicator from a native app of a buyer device.

24. The system according to claim 15, wherein the at least one processor is configured to present to a buyer device a request for confirmation of the recipient, the request including one or more candidate recipients in the database having at least a portion of the recipient information.

25. A machine-readable storage medium having computer-executable instructions stored thereon that, when executed by one or more processors, cause the one or more processors to perform operations comprising:
receiving information for a recipient of an online order associated with a merchant, the online order for delivery to the recipient;
querying a database using the recipient information to obtain a destination address of the recipient;
generating a token corresponding to the destination address of the recipient, wherein the token includes an obfuscated representation of the destination address of the recipient;
transmitting the token to a client device for submission of the online order for delivery to the recipient, wherein the token is adapted to satisfy a requirement to provide the destination address for the online order; and
responsive to the computer receiving the token from a merchant device associated with the merchant that received the order, presenting the destination address to the merchant device.
